(19) United States
(12) Patent Application Publication
(10) Pub. No.: US 2025/0157371 A1
(43) Pub. Date: May 15, 2025

(54) METHOD AND APPARATUS FOR COMPENSATING FOR DISPLAY DEFECT, MEDIUM, ELECTRONIC DEVICE, AND DISPLAY APPARATUS

(71) Applicants: Hefei BOE Joint Technology Co., Ltd., Hefei, Anhui (CN); BOE TECHNOLOGY GROUP CO., LTD., Beijing (CN)

(72) Inventors: Pengfei YIN, Beijing (CN); Mingi CHU, Beijing (CN); Jingbo XU, Beijing (CN); Huihui LI, Beijing (CN); Wenchao BAO, Beijing (CN)

(21) Appl. No.: 18/725,165

(22) PCT Filed: Dec. 21, 2021
(86) PCT No.: PCT/CN2021/142720

§ 371 Date: Jun. 28, 2024

(51) Int. Cl. G09G 3/00; G09G 3/3225; G09G 3/36

(52) U.S. Cl. CPC G09G 3/006; G09G 3/3225; G09G 3/3648; G09G 2320/0233; G09G 2320/045; G09G 2330/10; G09G 2360/16

(57) ABSTRACT

A method and apparatus for compensating a display defect, a medium, an electronic device, and a display apparatus. The method comprises: selecting a pixel value of a normal region at the periphery of a defective region to perform interpolation with respect to the defective region, so as to determine a compensation pixel value for the defective region at a preset brightness level; and updating a pixel value of the defective region at the preset brightness level with the compensation pixel value.

### CROSS-REFERENCE TO RELATED APPLICATIONS

The present disclosure is a U.S. National Stage of International Application No. PCT/2021/142720, filed on Dec. 29, 2021, entitled “METHOD AND APPARATUS FOR COMPENSATING FOR DISPLAY DEFECT, MEDIUM, ELECTRONIC DEVICE, AND DISPLAY APPARATUS”, the entire content of which is incorporated herein by reference.

### TECHNICAL FIELD

The present disclosure relates to a technical field of display, in particular to a method and an apparatus for compensating a display defect, a medium, an electronic device and a display apparatus.

### BACKGROUND

Nowadays, a size of display panel is getting bigger and bigger, and the display resolution is getting higher and higher. At present, the display brightness level of the display panel is uneven, which affects the display effect.

At present, the problem of uneven brightness level may be solved by a method for compensating. When pixel values at a periphery of a defective region changes greatly, updating a pixel value of the defective region with a pixel value of a normal region may cause the compensation for the defective region to be uneven.

It should be noted that information disclosed in the above background is only used to enhance the understanding of the background of the present disclosure, so it may include information that does not form the prior art known to those of ordinary skill in the art.

### SUMMARY

A purpose of the present disclosure is to overcome shortcomings of the above prior art and provide a method and an apparatus for compensating a display defect, a medium, an electronic device and a display apparatus.

According to one aspect of the present disclosure, a method for compensating a display defect is provided, which includes: acquiring a first captured image of a display panel; identifying a defective region and a normal region of the display panel based on the first captured image, where the defective region includes a defective pixel point and the normal region includes a normal pixel point; acquiring a second captured image of the display panel at a preset brightness level when the display panel is in a display state; obtaining a compensation pixel value for the defective pixel point at the preset brightness level by performing an interpolation computation on a pixel value of the normal pixel point of the second captured image; repeatedly acquiring compensation pixel values for all defective pixel points; updating a pixel value of the defective pixel point corresponding to the preset brightness level with the compensation pixel value to form a compensation image.

In an embodiment of the present disclosure, the pixel point includes a plurality of different sub-pixel points, and the compensation pixel value includes a plurality of compensation sub-pixel values corresponding to the sub-pixel points, obtaining the compensation pixel value for the defective pixel point at the preset brightness level by performing the interpolation computation on a pixel value of the normal pixel point of the second captured image includes: performing the interpolation computation on sub-pixel value of a normal sub-pixel point, corresponding to a defective sub-pixel point, at periphery of the defective sub-pixel point of the second captured image to determine the compensation sub-pixel value for the defective sub-pixel point at the preset brightness level; and updating the pixel value of the pixel point in the defective region at the preset brightness level with the compensation pixel value to form the compensation image includes: updating the sub-pixel value of the defective sub-pixel point at the preset brightness level with the compensation sub-pixel value, to form the compensation image.

In an embodiment of the present disclosure, performing the interpolation computation on the sub-pixel value of the normal sub-pixel point, corresponding to the defective sub-pixel point, at the periphery of the defective sub-pixel point of the second captured image to determine the compensation sub-pixel value for the defective sub-pixel point at the preset brightness level includes: selecting one defective sub-pixel point in the defective region; extracting the sub-pixel values of the plurality of sub-pixel points in the second captured image; searching a normal sub-pixel point closest to the defective sub-pixel point from the normal region in at least four different directions, and recording the sub-pixel values of at least four normal sub-pixel points; and taking a distance between the defective sub-pixel point and the normal sub-pixel point as a weight, and performing a weighting operation on the sub-pixel values of the at least four normal sub-pixel points to obtain the compensation sub-pixel value for the defective sub-pixel point.

In an embodiment of the present disclosure, taking the distance between the defective sub-pixel point and the normal sub-pixel point as the weight, and performing the weighting operation on the sub-pixel values of the at least four normal sub-pixel points to obtain the compensation sub-pixel value for the defective sub-pixel point includes:

$$f ( {x}_{i} , {y}_{j} ) = \frac{( i - 1 ) * ( j - 1 )}{( m - 1 ) * ( n - 1 )} f ( {x}_{1} , {y}_{1} ) + \frac{( i - 1 ) * ( n - j )}{( m - 1 ) * ( n - 1 )} f ( {x}_{1} , {y}_{n} ) + \frac{( m - i ) * ( j - 1 )}{( m - 1 ) * ( n - 1 )} f ( {x}_{m} , {y}_{1} ) + \frac{( m - i ) * ( n - j )}{( m - 1 ) * ( n - 1 )} f ( {x}_{m} , {y}_{n} )$$

in which, f (xᵢ, yⱼ) is the compensation sub-pixel value for the defective sub-pixel point, f (x₁, y₁), f (x₁, yₙ), f (xₘ, y₁) and f (xₘ, yₙ) are all sub-pixel values of the normal sub-pixel points,

$$\frac{( i - 1 ) * ( j - 1 )}{( m - 1 ) * ( n - 1 )}$$

is a weight of f (x₁, y₁),

$$\frac{( i - 1 ) * ( n - j )}{( m - 1 ) * ( n - 1 )}$$

is a weight of f (x₁, yₙ),

$$\frac{( m - i ) * ( j - 1 )}{( m - 1 ) * ( n - 1 )}$$

is a weight of f (xₘ, y₁), and

$$\frac{( m - i ) * ( n - j )}{( m - 1 ) * ( n - 1 )}$$

is a weight of f (xₘ, yₙ), i and m represent sequence numbers of different x, and j and n represent sequence numbers of different y.

In an embodiment of the present disclosure, taking the distance between the defective sub-pixel point and the normal sub-pixel point as the weight, and performing the weighting operation on the sub-pixel values of the at least four normal sub-pixel points to obtain the compensation sub-pixel value for the defective sub-pixel point includes:

$$f ( a + {u}_{0} , b + {v}_{0} ) = A * B * C$$

in which,

$$\begin{matrix}A = [ \begin{matrix}w ( 1 + u ) & w ( u ) & w ( 1 - u ) & w ( 2 - u )\end{matrix} ] \\ C = [ \begin{matrix}w ( 1 + v ) & w ( v ) & w ( 1 - v ) & w ( 2 - v )\end{matrix} ] \\ B = [ \begin{matrix}f ( a - 1 , b - 1 ) & f ( a - 1 , b ) & f ( a - 1 , b ) & f ( a - 1 , g + 1 ) \\ f ( a , b - 1 ) & f ( a , b ) & f ( a , h ) & f ( a , h + 1 ) \\ f ( a , b - 1 ) & f ( a , b ) & f ( g , h ) & f ( g , h + 1 ) \\ f ( g + 1 , b - 1 ) & f ( g + 1 , b ) & f ( g + 1 , h ) & f ( g + 1 , h + 1 )\end{matrix} ]\end{matrix}$$

a weighted sum function is:

$$w ( x ) = \{ \begin{matrix}1 - 2 {\vert x \vert}^{2} + {\vert x \vert}^{3} & , \vert x \vert < 1 \\ 4 - 8 \vert x \vert + 5 {\vert x \vert}^{2} - {\vert x \vert}^{3} & , 1 \leq \vert x \vert < 2 \\ 0 & \vert x \vert \geq 2\end{matrix}$$

one normal sub-pixel point is (a, b), another normal sub-pixel point is (g, h), and u₀ and v₀ are distances between the defective sub-pixel point and the normal sub-pixel point (a, b) in a first direction and a second direction, respectively, where the distances are normalized as

$$u = \frac{{u}_{0}}{g - a} and v = \frac{{v}_{0}}{h - b} ,$$

and a weight of the normal sub-pixel point (a, b) is w=w(u)*w(v); and A*C is a weight array of all normal sub-pixels, B is a sub-pixel value array of all normal sub-pixel points, and f (a+u₀, b+v₀) is the compensation sub-pixel value of the defective sub-pixel point.

In an embodiment of the present disclosure, the first captured image is acquired when the display panel is set in a non-display state, and identifying the defective region of the display panel based on the first captured image includes: extracting the sub-pixel value of each sub-pixel point in the first captured image; when a sub-pixel value of a sub-pixel point exceeds a first preset sub-pixel value interval, determining the sub-pixel point as the defective sub-pixel point; and determining all the defective sub-pixel points, where all the defective sub-pixel points form the defective region.

In an embodiment of the present disclosure, the first captured image is acquired when the display panel is set in the display state, and identifying the defective region of the display panel based on the first captured image includes: extracting the sub-pixel value of each sub-pixel point in the first captured image; when a sub-pixel value of a sub-pixel point exceeds a second preset sub-pixel value interval, determining the sub-pixel point as the defective sub-pixel point, where the second preset sub-pixel value interval is greater than the first preset sub-pixel value interval; and determining all the defective sub-pixel points, where all the defective sub-pixel points form the defective region.

In an embodiment of the present disclosure, before the performing the interpolation computation on the sub-pixel value of the normal sub-pixel point, corresponding to the defective sub-pixel point, at the periphery of the defective sub-pixel point of the second captured image, the method further includes: determining a deflection angle of the second captured image; and performing a coordinate axis conversion on the second captured image and performing a coordinate value conversion on sub-pixel points in the second captured image based on the deflection angle, to eliminate the deflection angle of the second captured image.

In an embodiment of the present disclosure, before the performing the interpolation computation on the sub-pixel value of the normal sub-pixel point, corresponding to the defective sub-pixel point, at the periphery of the defective sub-pixel point of the second captured image, the method further includes: determining whether an area of the defective region is less than a preset value; and when the area of the defective region is less than the preset value, updating the sub-pixel value of the defective sub-pixel point with a sub-pixel value of a normal sub-pixel point closest to the defective region.

In an embodiment of the present disclosure, before acquiring the first captured image of the display panel, the method further includes: acquiring a third captured image when the display panel is in a non-display state; determining whether a foreign matter presents on the display panel based on the third captured image; and cleaning the display panel in case that the foreign matter presents on the display panel.

In an embodiment of the present disclosure, the preset brightness level includes a plurality of preset brightness level values, and the compensation sub-pixel value for the defective sub-pixel point include a plurality of compensation sub-pixel values corresponding to the plurality of preset brightness level values; and the compensation sub-pixel value corresponding to the preset brightness level is used to update the sub-pixel value of the defective sub-pixel point, so as to form a compensation image.

According to another aspect of the present disclosure, an apparatus for compensating a display defect, is provided, which includes a first acquisition module, an identification module, a second acquisition module, a calculation module, a circulation module and a compensation module, where the first acquisition module is configured to acquire a first captured image of a display panel; the identification module is configured to identify a defective region and a normal region of the display panel based on the first captured image, where the defective region includes a defective pixel point and the normal region includes a normal pixel point; the second acquisition module is configured to acquire a second captured image at a preset brightness level when the display panel is in a display state; the calculation module is configured to obtain a compensation pixel value for the defective pixel point at the preset brightness level by performing an interpolation computation on a pixel value of the normal pixel point of the second captured image; the circulation module is configured to repeatedly acquire compensation pixel values of all of the defective pixel points; and the compensation module is configured to update a pixel value of the defective pixel point corresponding to the preset brightness level with the compensation pixel value to form a compensation image.

According to yet another aspect of the present disclosure, a non-transitory computer-readable storage medium is provided, on which a computer program is stored, and when the computer program is executed by a processor, the method described in one aspect of the present disclosure is implemented.

According to yet another aspect of the present disclosure, an electronic device is provided, including a processor and a memory configured to store an executable instruction of the processor; where the processor is configured to execute the method described in one aspect of the present disclosure via executing the executable instruction.

According to another aspect of the present disclosure, a display apparatus is provided, including a display panel and a controller, the controller including a compensation algorithm processor and a compensation parameter storage, the compensation parameter storage being configured to store an electrical compensation parameter and an optical compensation parameter, the compensation algorithm processor being configured to receive first image data of an image to be displayed on the display panel and call the electrical compensation parameter and the optical compensation parameter stored in the compensation parameter storage according to the first image data and perform a compensation calculation to generate compensated second image data to be displayed, where the optical compensation parameter is generated based on the compensated image according to any one aspect of the present disclosure and the image to be displayed.

In an embodiment of the present disclosure, the controller further includes an image processor, a driving controller and a sensing data converter; the sensing data converter is configured to convert a sensing signal sensed by the display panel into a digital signal and generate the electrical compensation parameter based on the digital signal; the image processor is configured to receive the second image data, and convert the second image data into digital quantity information required to light a corresponding sub-pixel; and the driving controller is configured to output a driving schedule required based on the digital quantity information, and display the image to be displayed.

In an embodiment of the present disclosure, the display apparatus includes: a substrate and a plurality of sub-pixels located in a display area, where the sub-pixels are arranged in a plurality of rows along a first direction and in a plurality of columns along a second direction, each row of sub-pixels includes a plurality of sub-pixels, and each column of sub-pixels includes a plurality of sub-pixels, and the first direction and the second direction intersect with each other.

In an embodiment of the present disclosure, the display apparatus further includes: a plurality of gate lines and a plurality of data lines arranged on a side of the substrate and located in the display area, where the plurality of gate lines extend in the first direction and the plurality of data lines extend in the second direction, sub-pixels in a same row are electrically connected with at least one of the gate lines, and sub-pixels in a same column are electrically connected with one of the data lines.

In an embodiment of the present disclosure, each of the sub-pixels includes a pixel driving circuit and a light emitting device electrically connected with the pixel driving circuit, one of the gate lines is electrically connected with a plurality of the pixel driving circuits of the sub-pixels in the same row, and one of the data lines is electrically connected with a plurality of the pixel driving circuits of the sub-pixels in the same column.

In an embodiment of the present disclosure, the pixel driving circuit includes a switching transistor, a driving transistor, a sensing transistor and a storage capacitor; where a control electrode of the switching transistor is electrically connected with a first gate signal terminal, a first electrode of the switching transistor is electrically connected with a data signal terminal, a second electrode of the switching transistor is electrically connected with a first node, the first gate signal terminal is electrically connected with one of the gate lines, and the data signal terminal is electrically connected with one of the data lines; the switching transistor is configured to transmit a data signal received at the data signal terminal to the first node in response to a first scan signal received at the first gate signal terminal; a control electrode of the driving transistor is electrically connected with the first node, a first electrode of the driving transistor is electrically connected with a sixth voltage signal terminal, and a second electrode of the driving transistor is electrically connected with a second node; the driving transistor is configured to be turned on under a control of a voltage of the first node, generate a driving signal according to the voltage of the first node and a sixth voltage signal received at the sixth voltage signal terminal, and transmit the driving signal to the second node; a first terminal of the storage capacitor is electrically connected with the first node, and a second terminal of the storage capacitor is electrically connected with the second node, and the switching transistor charges the storage capacitor while charging the first node; an anode of the light emitting device is electrically connected with the second node, and a cathode of the light emitting device is electrically connected with a seventh voltage signal terminal; the light emitting device is configured to emit light under a driving of the driving signal; a control electrode of the sensing transistor is electrically connected with a second gate signal terminal, a first electrode of the sensing transistor is electrically connected with the second node, a second electrode of the sensing transistor is electrically connected with a sensing signal terminal, the second gate signal terminal is electrically connected with another one of the gate lines, and the sensing signal terminal is electrically connected with another one of the data lines; and the sensing transistor is configured to detect a threshold voltage and/or carrier mobility of the driving transistor in response to a second scan signal received at the second gate signal terminal.

It should be understood that the above general description and the following detailed description are merely exemplary and explanatory, and cannot limit the present disclosure.

### BRIEF DESCRIPTION OF THE DRAWINGS

The accompanying drawings, which are incorporated in and constitute a part of the description, illustrate embodiments consistent with the present disclosure and together with the description serve to explain the principles of the present disclosure. Obviously, the drawings in the following description are some embodiments of the present disclosure, and for those of ordinary skill in the art, other drawings can also be obtained from these drawings without creative efforts.

FIG. 1 is a schematic structural diagram of a compensation system according to the related art.

FIG. 2 is a schematic diagram of an adjacent interpolation method according to the related art.

FIG. 3 is a schematic structural diagram of a defective region according to the related art.

FIG. 4 is a schematic structural diagram of another defective region according to the related art.

FIG. 5 is a schematic structural diagram of another defective region according to the related art.

FIG. 6 is a schematic diagram of compensating a relatively small defective region according to the related art.

FIG. 7 is a schematic diagram before compensating a relatively large defective region according to the related art.

FIG. 8 is a schematic diagram after compensating a relatively large defective region according to the related art.

FIG. 9 is a schematic structural diagram of a compensation system according to an embodiment of the present disclosure.

FIG. 10 is a schematic structural diagram of an apparatus for compensating a display defect, according to an embodiment of the present disclosure.

FIG. 11 is a schematic structural diagram of a controller according to an embodiment of the present disclosure.

FIG. 12 is a flowchart of data transmission in a controller according to an embodiment of the present disclosure.

FIG. 13 is a circuit diagram of a display panel according to the related art.

FIG. 14 is a circuit diagram of a sub-pixel according to the related art.

FIG. 15 is an oscillograph of different signal terminals and nodes during an operation process of a sub-pixel according to the related art.

FIG. 16 is a flowchart of a generation process of an optical compensation parameter according to an embodiment of the present disclosure.

FIG. 17 is a flowchart of a method for compensating according to an embodiment of the present disclosure.

FIG. 18 is a schematic diagram before compensating a relatively large defective region according to an embodiment of the present disclosure.

FIG. 19 is a schematic diagram after compensating a relatively large defective region according to an embodiment of the present disclosure.

FIG. 20 is a schematic diagram of a linear interpolation method according to an embodiment of the present disclosure.

FIG. 21 is a schematic diagram of a cubic interpolation method according to an embodiment of the present disclosure.

FIG. 22 is a schematic diagram of a method for determining a deflection angle of a sub-pixel point according to an embodiment of the present disclosure.

FIG. 23 is a position diagram of coordinate conversion of each sub-pixel point according to an embodiment of the present disclosure.

FIG. 24 is a schematic structural diagram of an electronic device according to an embodiment of the present disclosure.

### REFERENCE SIGNS

1. Image acquisition apparatus; 2. Processor; 3. Display panel, 31. Defective region, 32. Normal region; 4. Controller, 41. Sensing data converter, 42. Compensation parameter storage, 43. Compensation algorithm processor, 44. Image processor, 45. Driving controller; 5. Light source; 6. Power source.

### DETAILED DESCRIPTION

Exemplary implementations are hereinafter described more fully with reference to the accompanying drawings. However, the exemplary implementations may be implemented in various forms, and shall not be constructed as limited to the implementations set forth herein. On the contrary, provision of these implementations may enable the present disclosure to be more comprehensive and complete, and thereby conveying the concept of the exemplary implementations to those skilled in the art. The same reference signs in the drawings may indicate the same or similar structures, and thus their detailed descriptions are omitted. Furthermore, the accompanying drawings are merely schematic illustrations of the present disclosure, and are not necessarily drawn to scale.

Although relative terms such as “up” and “down” are adopted in this specification to describe the relative relationship of one component to another represented by a reference sign, these terms are adopted in this specification only for convenience, for example, based on the direction of the example described in the accompanying drawings. It can be understood that if the device shown by the reference sign is flipped to make it upside down, the component described as being “up” may become the component described as being “down.” In the case that a structure is “on” other structures, it may mean that a structure is integrally formed on other structures, or that a structure is “directly” provided on other structures, or that a structure is “indirectly” provided on other structures via another structure.

The terms “one”, “a”, “the”, “said” and “at least one” are used to indicate the existence of one or more elements, components or the like. The terms “include” and “have” are used to indicate an open-ended inclusion and to mean that additional elements, components or the like may exist besides the listed elements, components or the like. The terms “first”, “second” and “third” and the like are used merely as labels, and are not intended to limit the number of objects.

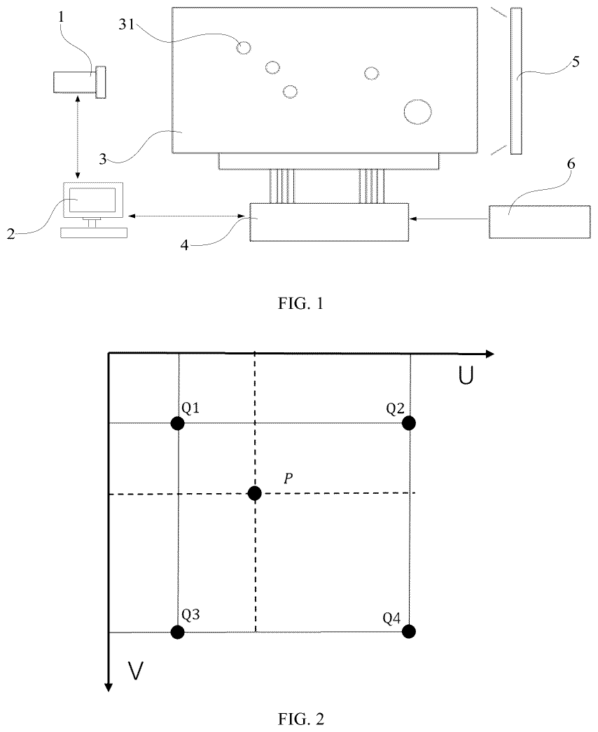

A schematic structural diagram of a compensation system according to the related art is shown in FIG. 1. The compensation system includes an image acquisition apparatus 1, a processor 2, a display panel 3, a controller 4 (TCON), a light source 5 and a power source 6. The display panel 3 and the controller 4 form a display apparatus; the power source 6 supplies power to the display apparatus through the controller 4, the light source 5 illuminates the display panel 3, the image acquisition apparatus 1 is used to capture pictures of the display panel 3 with different brightness level values, and an apparatus 2 for compensating a display defect, generates optical compensation parameters according to the captured images with different brightness level values. The controller 4 combines corresponding optical compensation parameters and corresponding electrical compensation parameters to compensate the first image data of the image to be displayed, to generate a compensated second image data to be displayed and display the image to be displayed based on the second image data.

It should be noted that, due to factors such as oil particles on the display panel 3, it is necessary to remove the interferent on the display region of the display panel 3 in advance and filter out a defective region 31 of a captured image. A conventional process is to clean the display panel 3, capture images of different sub-pixels with different brightness level values, then detect the defective region 31 and compensate for the defective region 31, and replace the sub-pixel value of the defective region 31 with a sub-pixel value of an adjacent normal region 32. As shown in FIG. 2 below, the adjacent interpolation solution uses a sub-pixel value of the nearest position to replace the sub-pixel value of the defective region 31. Q₁, Q₂, Q₃ and Q₄ are four normal sub-pixel points around a point P, and Q₁ is closest to the point P, so a value of the point P is equal to a value of Q₁.

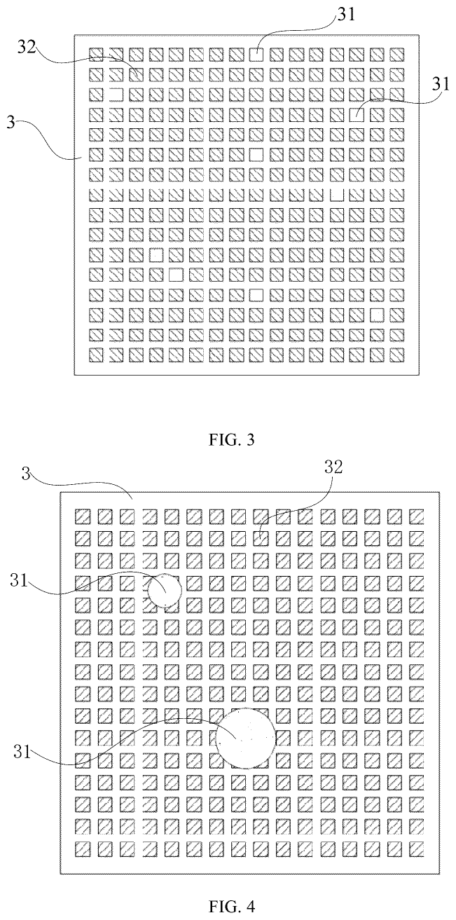

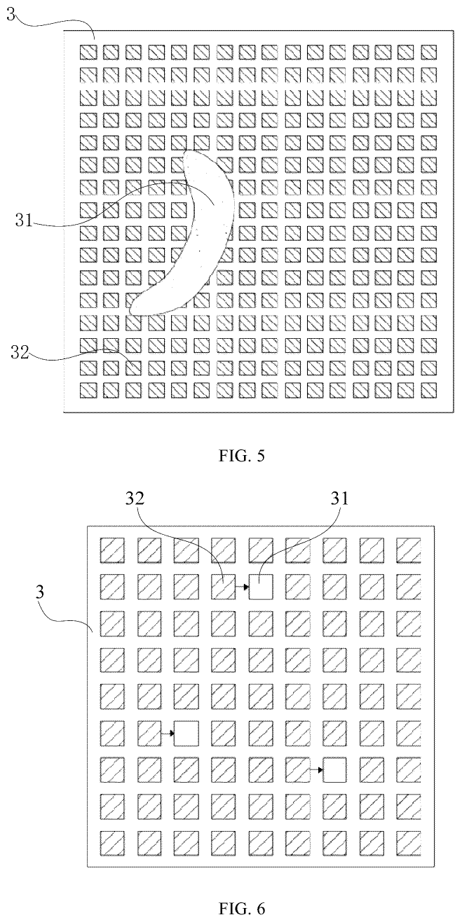

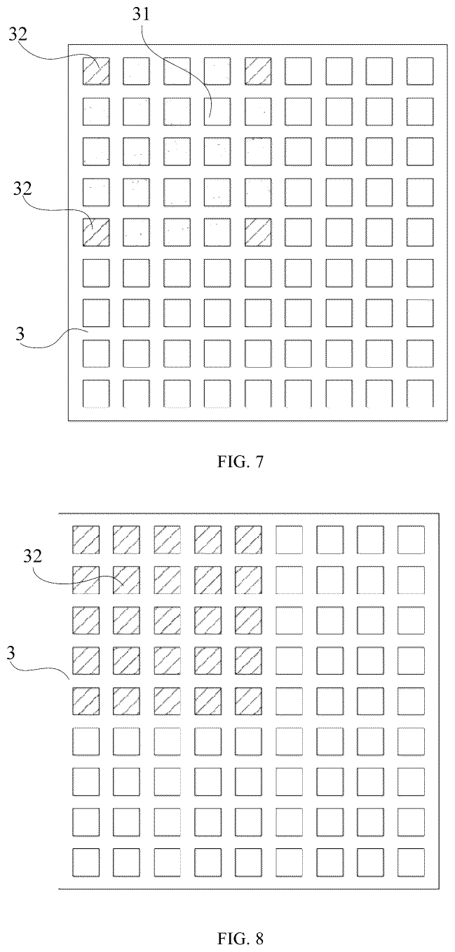

An image detection algorithm is used to detect the defective region 31, and common defective types include three types as shown in FIGS. 3 to 5. FIG. 3 is a point-like defective region with a relatively small area, FIG. 4 is a circular defective region with a relatively large area, and FIG. 5 is an irregular defective region with a relatively large area. As shown in FIG. 6, the sub-pixel value of the defective region 31 is replaced by the sub-pixel value of the adjacent normal region 32 by using an adjacent region replacement method for the defective region 31 with a relatively small region. As shown in FIGS. 7 and 8, for a defective region 31 with a relatively large area, the sub-pixel value of the defective region 31 is also replaced with a surrounding normal region 32. However, when a variation of the sub-pixel values surrounding a large-area defective region 31 is relatively large, using the surrounding sub-pixel values to replace will make the compensation for the defect uneven.

In view of the above problems, an exemplary implementation of the present disclosure provides a method for compensating a display defect. Application scenarios of this method for compensating include, but are not limited to: in a process of compensating the display defect, the display panel 3 is set at different preset brightness level values, the image acquisition apparatus 1 acquires the captured images at different preset brightness level values, and the apparatus 2 for compensating a display defect, identifies the defective region 31 according to the captured images and compensates for the defective region 31.

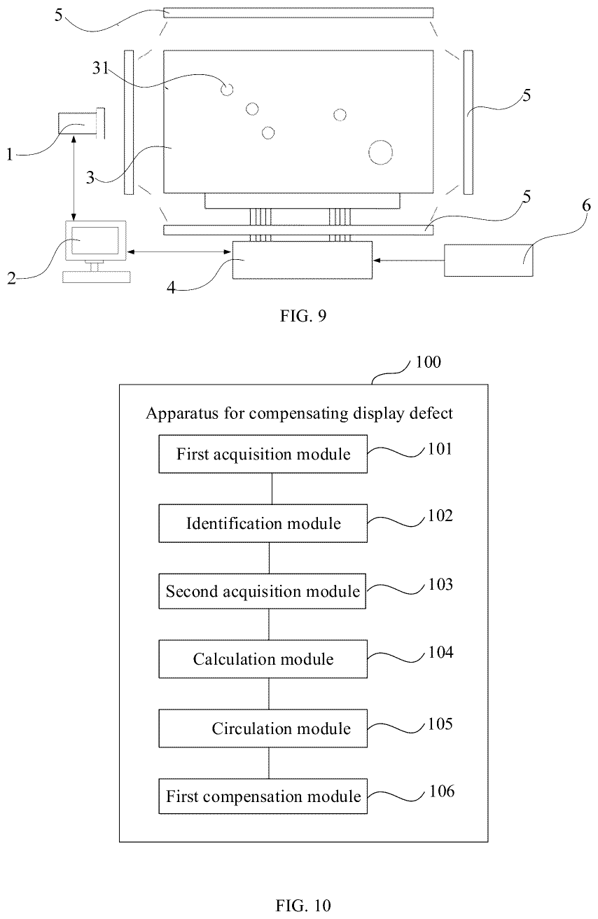

In order to realize the above method, an exemplary implementation of the present disclosure provides a compensation system for a display defect. FIG. 9 shows a structural schematic diagram of the compensation system for the display defect. As shown in the figure, the compensation system may include an image acquisition apparatus 1, an apparatus 2 for compensating a display defect, a display panel 3, a controller 4 (TCON), a power source 6 and light sources 5 arranged on four different sides of the edge of the display panel 3. The display panel 3 and the controller 4 form a display apparatus. The power source 6 supplies power to the display apparatus through the controller 4, the light sources 5 illuminate the display panel 3, the image acquisition apparatus 1 is used to capture pictures of the display panel 3 with different brightness values, and the apparatus 2 for compensating a display defect, generates optical compensation parameters according to the captured images with different brightness values. The controller 4 displays the images to be displayed in combination with the optical compensation parameters and the electrical compensation parameters.

The image acquisition apparatus 1 may be configured to acquire a first captured image when the display panel 3 is in a non-display state, and to acquire a second captured image when the display panel 3 is set to a preset brightness level. The image acquisition apparatus 1 may be a camera, a video camera, a smart phone or a computer with a photographing function. The image acquisition apparatus 1 used in the implementation of the present disclosure is a CCD camera, and the image resolution of the CCD camera is at least three times higher than the resolution of the display panel 3, such that the accurate pixel value of each pixel can be effectively distinguished.

The processor 2 may be connected with the image acquisition apparatus 1 through a network, and the processor 2 may be a smart phone, a personal computer, a tablet computer and the like with an image display and processing function. The processor 2 may include an apparatus for compensating a display defect.

As shown in FIG. 10, an apparatus 100 for compensating a display defect, includes a first acquisition module 101, an identification module 102, a second acquisition module 103, a calculation module 104, a circulation module 105 and a first compensation module 106. The first acquisition module 101 is configured to acquire a first captured image of a display panel; the identification module 102 is configured to identify a defective region and a normal region of the display panel based on the first captured image, where the defective region includes a defective pixel point and the normal region includes a normal pixel point; the second acquisition module 103 is configured to acquire a second captured image at a preset brightness level when the display panel is in a display state; the calculation module 104 is configured to obtain a compensation pixel value for the defective pixel point at the preset brightness level by performing an interpolation computation on a pixel value of the normal pixel point of the second captured image; the circulation module 105 is configured to repeatedly acquire compensation pixel values for all defective pixel points; and the compensation module is configured to update a pixel value of the defective pixel point corresponding to the preset brightness level with the compensation pixel value to form a compensation image.

In an implementation of the present disclosure, the pixel point includes a plurality of different sub-pixel points, and the compensation pixel value includes a plurality of compensation sub-pixel values corresponding to the sub-pixel points. The calculation module 104 may be specifically configured to: perform the interpolation computation on a sub-pixel value of a normal sub-pixel point of the second captured image to determine the compensation sub-pixel value for the defective sub-pixel point at the preset brightness level; and the compensation module may be specifically configured to update the sub-pixel value of the defective sub-pixel point at the preset brightness level with the compensation sub-pixel value, to form a compensation image.

In an implementation of the present disclosure, the calculation module 104 may be specifically configured to: select one defective sub-pixel point in the defective region; extract sub-pixel values of a plurality of sub-pixel points in the second captured image; search a normal sub-pixel point closest to the defective sub-pixel point from the normal region in at least four different directions, and record sub-pixel values of at least four normal sub-pixel points; and take a distance between the defective sub-pixel point and the normal sub-pixel point as a weight, and perform a weighting operation on the sub-pixel values of the at least four normal sub-pixel points to obtain the compensation sub-pixel value for the defective sub-pixel point.

In an implementation of the present disclosure, the calculation module 104 may be specifically configured to execute the following formula:

$$f ( {x}_{i} , {y}_{j} ) = \frac{( i - 1 ) * ( j - 1 )}{( m - 1 ) * ( n - 1 )} f ( {x}_{1} , {y}_{1} ) + \frac{( i - 1 ) * ( n - j )}{( m - 1 ) * ( n - 1 )} f ( {x}_{1} , {y}_{n} ) + \frac{( m - i ) * ( j - 1 )}{( m - 1 ) * ( n - 1 )} f ( {x}_{m} , {y}_{1} ) + \frac{( m - i ) * ( n - j )}{( m - 1 ) * ( n - 1 )} f ( {x}_{m} , {y}_{n} )$$

in which, f (xᵢ, yⱼ) is the compensation sub-pixel value for the defective sub-pixel point, f (x₁, y₁), f (x₁, yₙ), f (xₘ, y₁) and f (xₘ, yₙ) are all sub-pixel values of the normal sub-pixel points,

$$\frac{( i - j ) * ( j - 1 )}{( m - 1 ) * ( n - 1 )}$$

is a weight of f (x₁, y₁),

$$\frac{( i - 1 ) * ( n - j )}{( m - 1 ) * ( n - 1 )}$$

is a weight of f (x₁, yₙ),

$$\frac{( m - i ) * ( j - 1 )}{( m - 1 ) * ( n - 1 )}$$

is a weight of f (xₘ, y₁), and

$$\frac{( m - i ) * ( n - j )}{( m - 1 ) * ( n - 1 )}$$

is a weight of f (xₘ, yₙ), i and m represent sequence numbers of different x, and j and n represent sequence numbers of different y.

In an implementation of the present disclosure, the calculation module 104 may be specifically configured to execute the following formula:

$$f ( a + {u}_{0} , b + {v}_{0} ) = A * B * C$$

in which,

$$\begin{matrix}A = [ \begin{matrix}w ( 1 + u ) & w ( u ) & w ( 1 - u ) & w ( 2 - u ) ]\end{matrix} \\ C = [ \begin{matrix}w ( 1 + v ) & w ( v ) & w ( 1 - v ) & w ( 2 - v ) ]\end{matrix} \\ B = [ \begin{matrix}f ( a - 1 , b - 1 ) & f ( a - 1 , b ) & f ( a - 1 , b ) & f ( a - 1 , g + 1 ) \\ f ( a , b - 1 ) & f ( a , b ) & f ( a , h ) & f ( a , h + 1 ) \\ f ( a , b - 1 ) & f ( a , b ) & f ( g , h ) & f ( g , h + 1 ) \\ f ( g + 1 , b - 1 ) & f ( g + 1 , b ) & f ( g + 1 , h ) & f ( g + 1 , h + 1 )\end{matrix} ]\end{matrix}$$

a weighted sum function is:

$$w ( x ) = \{ \begin{matrix}1 - 2 {\vert x \vert}^{2} + {\vert x \vert}^{3} & , \vert x \vert < 1 \\ 4 - 8 \vert x \vert + 5 {\vert x \vert}^{2} - {\vert x \vert}^{3} & , 1 \leq \vert x \vert < 2 \\ 0 & \vert x \vert \geq 2\end{matrix}$$

one normal sub-pixel point is (a, b), another normal sub-pixel point is (g, h), and u₀ and v₀ are distances between the defective sub-pixel point and the normal sub-pixel point (a, b) in a first direction and a second direction, respectively, where the distances are normalized as

$$u = \frac{{u}_{0}}{g - a} and v = \frac{{v}_{0}}{h - b} ,$$

and a weight of the normal sub-pixel point (a, b) is w=w(u)*w(v); and A*C is a weight array of all normal sub-pixel points, B is a sub-pixel value array of all normal sub-pixel points, and f(a+u₀, b+v₀) is the compensation sub-pixel value for the defective sub-pixel point.

In an implementation of the present disclosure, the first captured image is acquired when the display panel is set in the non-display state, and the identification module 102 may be specifically configured to: extract the sub-pixel value of each sub-pixel point in the first captured image; when a sub-pixel value of a sub-pixel point exceeds a first preset sub-pixel value interval, determine the sub-pixel point as the defective sub-pixel point; and determine all the defective sub-pixel points, where all the defective sub-pixel points form the defective region.

In an implementation of the present disclosure, the first captured image is acquired when the display panel is set in the display state, and the identification module 102 may be specifically configured to: extract the sub-pixel value of each sub-pixel point in the first captured image; when a sub-pixel value of a sub-pixel point exceeds a second preset sub-pixel value interval, determine the sub-pixel point as the defective sub-pixel point, where the second preset sub-pixel value interval is greater than the first preset sub-pixel value interval; and determine all the defective sub-pixel points, where all the defective sub-pixel points form the defective region.

In an implementation of the present disclosure, the apparatus further includes an offset module configured to: determine a deflection angle of the second captured image; and perform a coordinate axis conversion on the second captured image and perform a coordinate value conversion on sub-pixel points in the second captured image based on the deflection angle, to eliminate the deflection angle of the second captured image.

In an implementation of the present disclosure, the apparatus further includes a determination module and a second compensation module. The determination module may be configured to: determine whether an area of the defective region is less than a preset value; and the second compensation module may be configured to: update the sub-pixel value of the defective sub-pixel point with a sub-pixel value of a normal sub-pixel point closest to the defective region when the area of the defective region is less than the preset value.

In an implementation of the present disclosure, the apparatus further includes a third acquisition module. The third acquisition module may be configured to: acquire a third captured image when the display panel is in a non-display state; determine whether a foreign matter presents on the display panel based on the third captured image; and clean the display panel if the foreign matter presents on the display panel.

In an implementation of the present disclosure, the preset brightness level includes a plurality of preset brightness level values, and the compensation sub-pixel value for the defective sub-pixel point include a plurality of compensation sub-pixel values corresponding to the plurality of preset brightness level values. Specifically, the first compensation module 106 may be configured to: update the sub-pixel value of the defective sub-pixel point in the defective region with the compensation sub-pixel value corresponding to the preset brightness level value, to form the compensation image.

The above display apparatus includes a display panel and a controller, and the display panel 3 may be a display panel of a display apparatus or a display panel of a display device. The display panel 3 may be set in a non-display state or a display state. In the display state, the display panel 3 may be set in a preset brightness level, and the preset brightness level may include a plurality of different brightness level values. The display panel 3 may be a pillar-type liquid crystal display screen and an organic light emitting diode (OLED) display panel. The display apparatus may be a television, a mobile phone, a computer monitor, an electronic reader, etc., and the display device may be a liquid crystal display module (LCM) or an organic light-emitting diode (OLED) display module, which is not limited by the implementation of the present disclosure.

The controller 4 may establish a connection with the apparatus for compensating a display defect, through a network. As shown in FIG. 11, the controller 4 includes a sensing data converter 41, a compensation parameter storage 42, a compensation algorithm processor 43, an image processor 44 and a driving controller 45.

The controller 4 may be configured to: acquire optical compensation parameters generated by the processor 2, and call the corresponding optical compensation parameters and pre-generated electrical compensation parameters based on a gray scale of an image to be displayed; generate image information of the image to be displayed based on the optical compensation parameters and the electrical compensation parameters; receive the image information; convert the image information into digital quantity information needed to light corresponding sub-pixel values; and output a time sequence required for driving the controller based on the digital quantity information to control the display panel 3 to display the image to be displayed.

The compensation parameter storage 42 may be configured to store the electrical compensation parameters and the optical compensation parameters, both of which are recorded in the compensation parameter storage 42 and provided to the compensation algorithm processor 43 for calling and updating.

The optical compensation parameters are generated based on the compensation image and the image to be displayed according to the implementation of the present disclosure.

The electrical compensation parameters are generated by the sensing data converter 41, and the sensing data converter 41 may be configured to convert a sensing signal sensed by the display panel into a digital signal and generate the electrical compensation parameters based on the digital signal. The digital signal is generally transmitted by adopting 8 bit or 10 bit.

The compensation algorithm processor 43 may be configured to receive first image data of the image to be displayed on the display panel, call the electrical compensation parameters and optical compensation parameters stored in the compensation parameter storage according to the first image data and perform a compensation calculation to generate compensated second image data to be displayed.

The image processor 44 may be configured to receive the second image data and convert the second image data into digital quantity information required to light the corresponding sub-pixel. The image processor 44 may also be configured to analyze and convert the second image data to convert RGB information included in the second image data into RGBW information.

The driving controller 45 outputs a driving schedule required based on the digital quantity information and displays the image to be displayed.

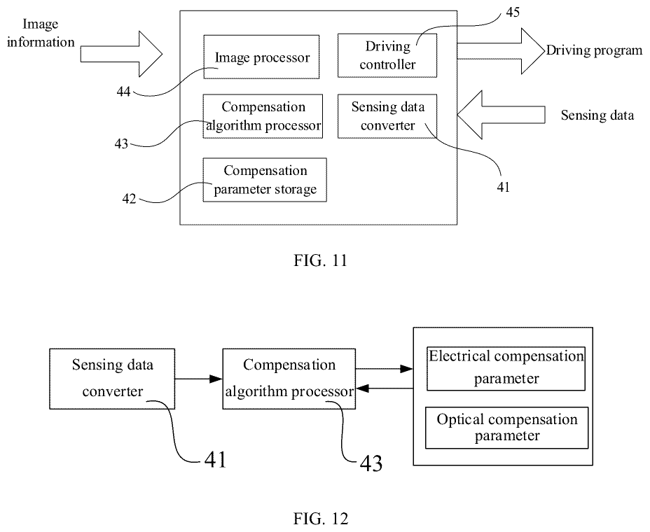

As shown in FIG. 12, the compensation parameter storage 42 contains two kinds of compensation parameters, namely, electrical compensation parameters and optical compensation parameters, in which the electrical compensation parameters are updated after each sensing signal is calculated by the compensation algorithm processor 43. According to the method for compensating according to the implementation of the present disclosure, the optical compensation parameters are generated and acquired.

Taking the above display panel as an OLED display panel (i.e., the display apparatus 2000 is an OLED display apparatus) as an example, an electrical compensation for the sub-pixel will be explained schematically.

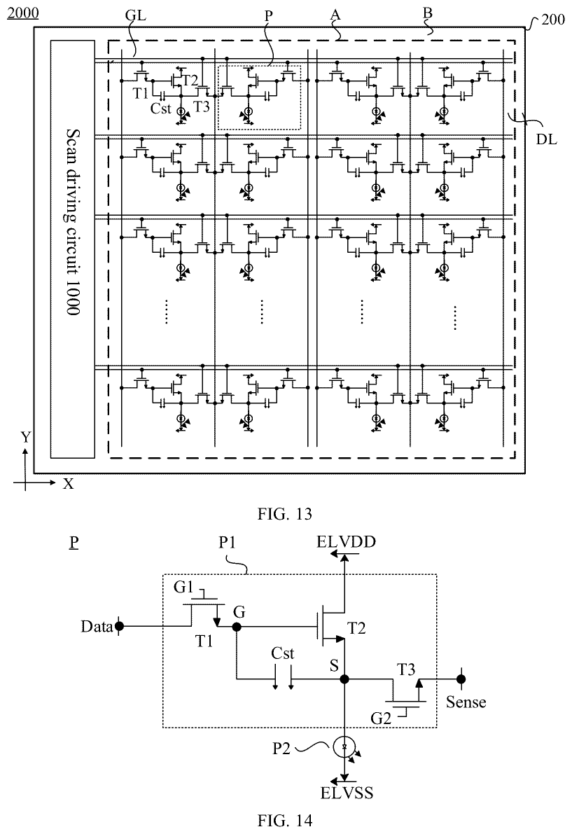

In some embodiments, as shown in FIG. 13, the display apparatus 2000 has a display area A and a border area B arranged beside the display area A. Here, “beside” refers to a side, two sides, three sides or peripheral sides of the display area A, that is, the border area B may be located on a side, two sides or three sides of the display area A, or the border area B may be arranged around the display area A.

In some embodiments, as shown in FIG. 13, the display apparatus 2000 may include: a substrate 200, a plurality of sub-pixels P, and a scan driving circuit 1000. The substrate 200 is used to carry the plurality of sub-pixels and the scan driving circuit 1000.

As an example, as shown in FIG. 13, the scan driving circuit 1000 may be located at the border area B. Of course, the scan driving circuit 1000 may also be arranged at other positions, and the present disclosure is not limited to this.

Here, the scan driving circuit 1000 may be, for example, a light emitting control circuit or a gate driving circuit. In the present disclosure, the scan driving circuit 1000 is taken as the gate driving circuit as an example to make a schematic illustration.

As an example, as shown in FIG. 13, the plurality of sub-pixels P may be located within the display area A. For example, the plurality of sub-pixels P may be arranged in a plurality of rows along a first direction X and in a plurality of columns along a second direction Y. Each row of sub-pixels P may include a plurality of sub-pixels, and each column of sub-pixels P may include a plurality of sub-pixels.

Here, the first direction X and the second direction Y may intersect with each other. An included angle between the first direction X and the second direction Y may be selected and set according to actual needs. As an example, the included angle between the first direction X and the second direction Y may be 85°, 89° or 90°, etc.

In some examples, as shown in FIG. 13, the display apparatus 2000 may further include: a plurality of gate lines GL and a plurality of data lines DL, which are arranged on a side of the substrate 200 and located in the display area A. The plurality of gate lines GL extend along the first direction X, and the plurality of data lines DL extend along the second direction Y.

As an example, the sub-pixels P arranged in a row along the first direction X may be called a same row of sub-pixels P, and the sub-pixels P arranged in a column along the second direction Y may be called a same column of sub-pixels P. The same row of sub-pixels P may be electrically connected with at least one gate line GL, and the same column of sub-pixels P may be electrically connected with one data line DL.

In some examples, as shown in FIG. 14, each of the plurality of sub-pixels P may include a pixel driving circuit P1 and a light emitting device P2 electrically connected with the pixel driving circuit P1. The light emitting device may be an OLED.

As an example, one gate line GL may be electrically connected with a plurality of pixel driving circuits P1 in the same row of sub-pixels P, and one data line DL may be electrically connected with a plurality of pixel driving circuits P1 in the same column of sub-pixels P.

The pixel driving circuit P1 has various structures, which may be selected and set according to actual needs. For example, the structures of the pixel driving circuit P1 may include structures such as “3T1C”, “6T1C”, “7T1C”, “6T2C” or “7T2C”. “T” represents transistors, the number before “T” represents the number of the transistors, “C” represents storage capacitors, and the number before “C” represents the number of the storage capacitors.

Here, during the use of the display apparatus 2000, the stability of the transistors in the pixel driving circuit P1 and the light emitting device P2 may decrease (for example, a threshold voltage drift of the driving transistor), which affects the display effect of the display apparatus 2000, so it is necessary to compensate for the sub-pixel P.

There are many ways to compensate for the sub-pixel P, and settings may be selected according to actual needs. For example, a pixel compensation circuit may be provided in the sub-pixel P to internally compensate for the sub-pixel P by the pixel compensation circuit. For another example, the driving transistor or light emitting device may be sensed by a transistor inside the sub-pixel P, and sensed data may be transmitted to an external sensing circuit, such that the external sensing circuit may be used to calculate a driving voltage value to be compensated and feedback the driving voltage value, thereby realizing an external compensation for the sub-pixel P.

In the present disclosure, the structure and working process of the sub-pixel P are illustrated schematically by taking the way of external compensation (sensing the driving transistor) and the structure of the pixel driving circuit as “3T1C” as an example.

As an example, as shown in FIG. 14, the pixel driving circuit P1 may include a switching transistor T1, a driving transistor T2, a sensing transistor T3, and a storage capacitor Cst.

For example, as shown in FIG. 14, a control electrode of the switching transistor T1 is electrically connected with a first gate signal terminal G1, a first electrode of the switching transistor T1 is electrically connected with a data signal terminal Data, a second electrode of the switching transistor T1 is electrically connected with a first node G, the first gate signal terminal G1 is electrically connected with one gate line GL, and the data signal terminal Data is electrically connected with one data line DL. The switching transistor T1 is configured to transmit the data signal received at the data signal terminal Data to the first node g in response to a first scan signal received at the first gate signal terminal G1.

Here, the data signal includes, for example, a detection data signal and a display data signal. The detection data signal is used in a blanking period and the display data signal is used in a display period. With regard to the display period and the blanking period, reference may be made to the following descriptions in some embodiments, which will not be repeated here.

For example, as shown in FIG. 14, a control electrode of the driving transistor T2 is electrically connected with the first node G, a first electrode of the driving transistor T2 is electrically connected with a sixth voltage signal terminal ELVDD, and a second electrode of the driving transistor T2 is electrically connected with a second node S. The driving transistor T2 is configured to be turned on under a control of a voltage at the first node G, generate a driving signal according to the voltage of the first node G and a sixth voltage signal received at the sixth voltage signal terminal ELVDD, and transmit the driving signal to the second node S.

For example, as shown in FIG. 14, a first terminal of the storage capacitor Cst is electrically connected with the first node G, and a second terminal of the storage capacitor Cst is electrically connected with the second node S. The switching transistor T1 charges the storage capacitor Cst while charging the first node G.

For example, as shown in FIG. 14, an anode of the light emitting device P2 is electrically connected with the second node S, and a cathode of the light emitting device P2 is electrically connected with a seventh voltage signal terminal ELVSS. The light emitting device P2 is configured to emit light under a driving of the driving signal.

For example, as shown in FIG. 14, a control electrode of the sensing transistor T3 is electrically connected with a second gate signal terminal G2, a first electrode of the sensing transistor T3 is electrically connected with the second node S, a second electrode of the sensing transistor T3 is electrically connected with a sensing signal terminal Sense, the second gate signal terminal G2 is electrically connected with another gate line GL, and the sensing signal terminal Sense is electrically connected with another data line DL. The sensing transistor T3 is configured to detect an electrical characteristic of the driving transistor T2 in response to a second scan signal received at the second gate signal terminal G2 to realize an external compensation. The electrical characteristic includes, for example, a threshold voltage and/or carrier mobility of the driving transistor T2.

Here, the sensing signal terminal Sense may provide a reset signal or acquire a sensing signal, where the reset signal is used to reset the second node S in the display period and the sensing signal is used to acquire the threshold voltage and/or carrier mobility of the driving transistor T2 in the blanking period.

Based on the structure of the pixel driving circuit P1, as shown in FIG. 13, a plurality of pixel driving circuits P1 in a same row of sub-pixels P may be electrically connected with two gate lines GL (i.e., a first gate line and a second gate line). For example, each first gate signal terminal G1 may be electrically connected with the first gate line and receive the first scan signal transmitted by the first gate line; and each second gate signal terminal G2 may be electrically connected with the second gate line and receive the second scan signal transmitted by the second gate line.

It should be noted that a display stage of one frame may include, for example, a display period and a blanking period that are sequentially performed.

In the display period of the display stage of one frame, as shown in FIG. 15, the working process of the sub-pixel P may include, for example, a reset stage t1, a data writing stage t2 and a light emitting stage t3.

In the reset stage t1, a level of the first scan signal is a high level, a level of the data signal terminal for example is a low level, a level of the second scan signal is a high level, and a level of the reset signal provided by the sensing signal terminal Sense is a low level. The switching transistor T1 is turned on under the control of the first scan signal, receives the data signal, and transmits the data signal to the first node G to reset the first node G. The sensing transistor T3 is turned on under the control of the second scan signal, receives the reset signal, and transmits the reset signal to the second node S to reset the second node S.

In the data writing stage t2, the level of the first scan signal is the high level, and the level of the data signal (that is, the display data signal) is the high level. Under the control of the first scan signal, the switching transistor T1 remains in a conducting state, receives the display data signal, transmits the display data signal to the first node G, and charges the storage capacitor Cst.

In the light emitting stage t3, the level of the first scan signal is the low level, the level of the second scan signal is the low level, and the level of the sixth voltage signal is the high level. The switching transistor T1 is turned off under the control of the first scan signal, and the sensing transistor T3 is turned off under the control of the second scan signal. The storage capacitor Cst starts to discharge, such that the voltage of the first node G is maintained at the high level. The driving transistor T2 is turned on under the control of the voltage of the first node G, receives the sixth voltage signal, generates a driving signal, and transmits the driving signal to the second node S to drive the light emitting device P2 to emit light.

During the blanking period in the display stage of one frame, the working process of the sub-pixel P may include, for example, a first stage and a second stage.

In the first stage, both the level of the first scan signal and the level of the second scan signal are the high level, and the level of the data signal (that is, the detection data signal) is the high level. The switching transistor T1 is turned on under the control of the first scan signal, receives the detection data signal, and transmits the detection data signal to the first node G to charge the first node G. The sensing transistor T3 is turned on under the control of the second scan signal, receives the reset signal provided by the sensing signal terminal Sense, and transmits the reset signal to the second node S.

In the second stage, the sensing signal terminal Sense is in a suspension state. The driving transistor T2 is turned on under the control of the voltage of the first node G, receives the sixth voltage signal, and transmits the sixth voltage signal to the second node S to charge the second node S, such that the voltage of the second node S rises until the driving transistor T2 is turned off. A voltage difference Vgs between the first node G and the second node S is equal to a threshold voltage Vth of the driving transistor T2.

Because the sensing transistor T3 is in the conducting state and the sensing signal terminal Sense is in the suspension state, the sensing signal terminal Sense will be charged at the same time when the driving transistor T2 charges the second node S. By sampling the voltage of the sensing signal terminal Sense (that is, acquiring the sensing signal), the threshold voltage Vth of the driving transistor T2 may be calculated according to a relationship between the voltage of the sensing signal terminal Sense and the level of the detection data signal.

After calculating the threshold voltage Vth of the driving transistor T2, the threshold voltage Vth may be compensated into the display data signal of the display period in a display stage of the next frame, and the external compensation for the sub-pixel P may be completed. Therefore, it should be understood that the electrical compensation parameter refers to the threshold voltage and/or carrier mobility of the driving transistor T2.

In some examples, the scan driving circuit 1000 and the plurality of sub-pixels P are located on the same side of the substrate 200. The scan driving circuit 1000 may include shift registers 100 cascaded in multiple stages. For example, a primary shift register 100 may be electrically connected with at least one row of sub-pixels P (that is, a plurality of pixel driving circuits P1 in the sub-pixels P).

It should be noted that in the display stage of one frame, both the first scan signal transmitted by the first gate signal terminal G1 and the second scan signal transmitted by the second gate signal terminal G2 are provided by the scan driving circuit 1000. That is, each shift register 100 in the scan driving circuit 1000 may be electrically connected with the first gate signal terminal G1 through the first gate line, transmit the first scan signal to the first gate signal terminal G1 through the first gate line, electrically connected with the second gate signal terminal G2 through the second gate line, and transmit the second scan signal to the second gate signal terminal G2 through the second gate line.

Of course, a plurality of pixel driving circuits P1 in the same row of sub-pixels P may be electrically connected with the same gate line GL. In this case, the first scan signal and the second scan signal are the same. Each shift register 1 in the scan driving circuit 1000 may be electrically connected with the first gate signal terminal G1 and the second gate signal terminal G2 through a corresponding gate line GL, and transmit the scan signal to the first gate signal terminal G1 and the second gate signal terminal G2 through the gate line GL.

The optical compensation parameters are generated based on the compensation images and the images to be displayed, and different compensation images and corresponding images to be displayed generate different optical compensation parameters, which may be stored in the compensation algorithm memory for subsequent call.

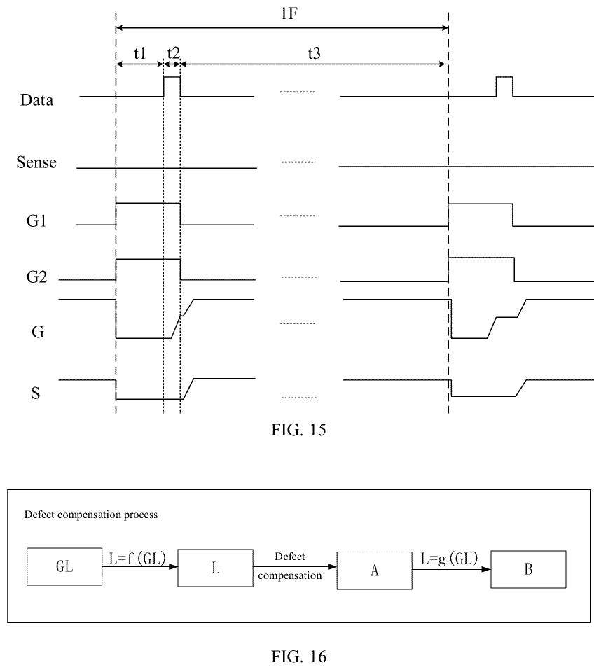

As shown in FIG. 16, it is assumed that the gray scale of a given input signal is GL, g(GL) is an optical compensation map, and f (GL) is an electrical compensation map. The image acquisition apparatus 1 captures a second captured image L with a preset brightness level value, and an interpolation computation is performed on the sub-pixel value of the normal sub-pixel point of the second captured image to determine the compensation sub-pixel value for the defective sub-pixel point with the preset brightness level value. The sub-pixel value of the defective sub-pixel point with the preset brightness level value is updated with the compensation sub-pixel value to form a compensation image A, and a mapping relationship: B=g(A), between the sub-pixel value of the compensation image A and the sub-pixel value of the image B to be displayed is established, which is the optical compensation parameter, and the optical compensation parameter is stored in the compensation parameter storage.

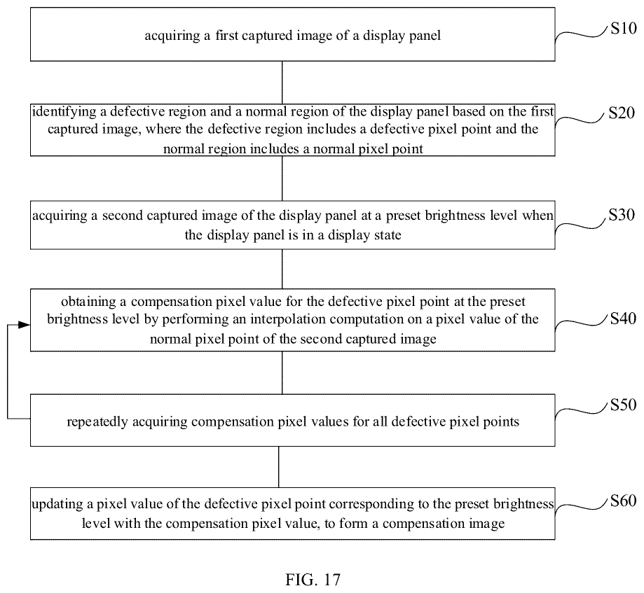

In the following, the method for compensating the display defect will be explained from a perspective of the processor. As shown in FIG. 17, an implementation of the present disclosure provides a system for compensating a display defect. The method includes the following steps S10-S60:
in step S10, acquiring a first captured image of a display panel;
in step S20, identifying a defective region and a normal region of the display panel based on the first captured image, where the defective region includes a defective pixel point and the normal region includes a normal pixel point.
in step S30, acquiring a second captured image of the display panel at a preset brightness level when the display panel is in a display state;
in step S40, obtaining a compensation pixel value for the defective pixel point at the preset brightness level by performing an interpolation computation on a pixel value of the normal pixel point of the second captured image;
in step S50, repeatedly acquiring compensation pixel values for all defective pixel points; and
in step S60, updating a pixel value of the defective pixel point corresponding to the preset brightness level with the compensation pixel value, to form a compensation image.

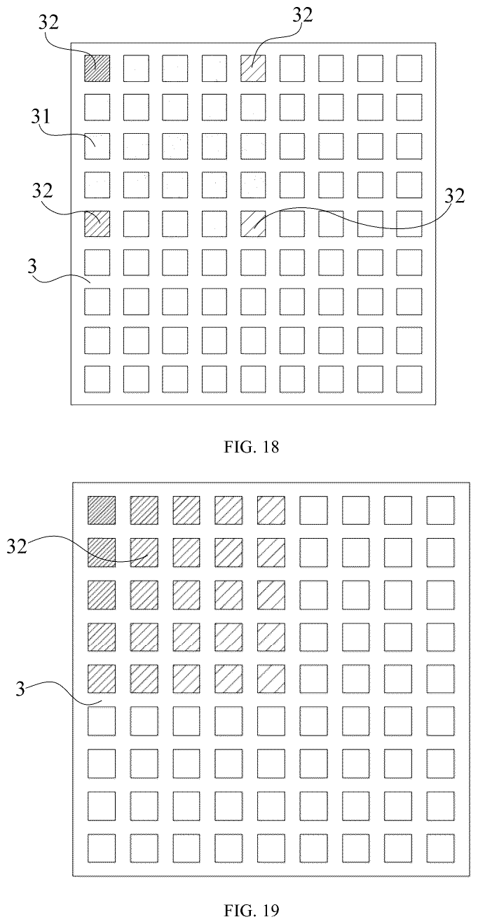

As shown in FIG. 18 and FIG. 19, the method selects a pixel value of a normal region 32 at the periphery of a defective region 31 to perform interpolation on the defective region 31, to determine a compensation pixel value for the defective region 31 at a preset brightness level, and updates a pixel value of the defective region 31 at the preset brightness level with the compensation pixel value. A smooth pixel value transition at the compensated defective region 31 can improve the display quality of the display panel 3. This method can effectively mitigate or eliminate the abnormal phenomenon of optical compensation caused by the defective region 31, and improve the uniformity of optical compensation.

Each step in FIG. 17 will be described in detail below.

In step S10, the first captured image of the display panel is acquired.

The defective region may include an external defect, and the external defect may specifically include a foreign matter located in the display region of the display panel and a scratch in the display region of the display panel, and the foreign matter may be dust and stains. These external defects will affect the integrity of the captured image, and then affect the effect of optical compensation.

Generally, before acquiring the first captured image, in the non-display state, the image acquisition apparatus 1 is used to capture the display region of the display panel to acquire one or more third captured images. Whether a foreign object presents in the display region of the display panel is determined based on the third captured image. If a foreign object presents in the display region of the display panel, the display panel is cleaned.

The display region of the display panel is captured by the image acquisition apparatus 1, and when the third captured image is obtained, the light from a side of the light source 5 may make the foreign object on the surface of the display panel more obvious.

However, usually cleaning cannot remove all external defects, such as stubborn stains and scratches in the display region of the display panel, so it is necessary to identify the defective regions formed by these types of external defects, that is, to acquire the first captured image when the display panel is in a non-display state.

Of course, a defective region without cleaning formed by dust and stains that can be cleaned can also be identified as the defective region.

In step S20, the defective region and the normal region of the display panel are identified based on the first captured image, where the defective region includes the defective pixel point and the normal region includes the normal pixel point.

A resolution of the first captured image is relatively high, and the sub-pixel value of each sub-pixel point in the first captured image can be extracted.

The first captured image may be acquired when the display panel is set in the non-display state. The sub-pixel value of each sub-pixel point in the first captured image will fall within a fixed sub-pixel value interval, for example, 30˜70 nits, so a comparison may be performed through a first preset sub-pixel value interval. Generally, the defective region includes a plurality of defective sub-pixel points, so it is necessary to determine all the defective sub-pixel points to identify the defective region of the display panel based on the first captured image.

Determining the defective sub-pixel points may include the following steps: extracting the sub-pixel value of each sub-pixel point in the first captured image; when a sub-pixel value of a sub-pixel point exceeds the first preset sub-pixel value interval, determining the sub-pixel point being the defective sub-pixel. One defective sub-pixel point may be acquired by performing the above steps, and the remaining defective sub-pixels may be determined by repeatedly performing the above steps. All defective sub-pixel points are determined, and all defective sub-pixel points form the defective region. When a sub-pixel value of a sub-pixel point is within the first preset sub-pixel value interval, it is determined that the sub-pixel point is a normal sub-pixel point, and all normal sub-pixel points form the normal region.

In addition, in order to avoid an inaccuracy of the preset sub-pixel value interval caused by a difference of brightness level uniformity when the size of the display panel is relatively large, the display region of the display panel will be divided into several display sub-region distributed in an array, and the respective first preset sub-pixel value interval will be defined in each display sub-region and the defects of each sub-display area will be determined respectively.

The first captured image may also be acquired when the display panel is set in the display state. The sub-pixel value of each sub-pixel point in the first captured image will fall within a fixed sub-pixel value interval, such as 50˜100 nits, so a comparison may be performed through a second preset sub-pixel value interval. It should be understood that the second preset sub-pixel value interval is larger than the first preset sub-pixel value interval. Determining the defective sub-pixel point may include the following steps: extracting the sub-pixel value of each sub-pixel point in the first captured image; when a sub-pixel value of a sub-pixel point exceeds the second preset sub-pixel value interval, determining the sub-pixel point being the defective sub-pixel. The above steps are repeated to determine the remaining defective sub-pixel points. All defective sub-pixel points are determined, and all defective sub-pixel points form the defective region. When a sub-pixel value of a sub-pixel point is within the second preset sub-pixel value interval, it is determined that the sub-pixel point is a normal sub-pixel point, and all normal sub-pixel points form the normal region.

It should be noted that the determination of the defective sub-pixel point includes determining the position of the defective sub-pixel point and the sub-pixel value of the defective sub-pixel point.

In step S30, when the display panel is in the display state, the second captured image of the display panel at the preset brightness level is acquired.

The display panel is set at the preset brightness level, and the second captured image is acquired.

The preset brightness level includes a plurality of preset brightness level values, the display panel may be respectively set at different brightness level values, and at least one second captured image may be acquired at each brightness level value.

In step S40, the interpolation computation is performed for the pixel value of the normal pixel point of the second captured image to obtain the compensation pixel value for the defective pixel point at the preset brightness level.

The pixel point includes a plurality of different sub-pixel points, and a resolution of the second captured image is relatively high, so the sub-pixel value of each sub-pixel point in the second captured image may be extracted. Performing the interpolation computation on the pixel values of normal pixel points of the second captured image to obtain the compensation pixel values for the defective pixel points at the preset brightness level may include: performing the interpolation computation on the sub-pixel value of the normal sub-pixel point, corresponding to the defective sub-pixel point, at the periphery of the defective sub-pixel point of the second captured image to determine the compensation sub-pixel value for defective sub-pixel point at the preset brightness level.

Different sub-pixels may usually include red sub-pixels, green sub-pixels and blue sub-pixels, and different sub-pixels may usually also include white sub-pixels. Taking the red sub-pixels as an example, the interpolation computation is performed on the sub-pixel values of different red sub-pixels in the normal region at the periphery of the defective region of the second captured image to determine the compensation sub-pixel values for the corresponding red sub-pixels in the defective region at the preset brightness level, and the compensation sub-pixel values are used to update the sub-pixel values of the red sub-pixels in the defective region at the preset brightness level. The interpolation computation and compensation update process of compensation sub-pixel values of green sub-pixel, blue sub-pixel and white sub-pixel may refer to the red sub-pixels, and will not be repeated here.

In step S50, step S40 is repeatedly executed, and the compensation pixel values for all of the defective pixel points may be acquired.

In step S60, the pixel value of the pixel point in the defective region at the preset brightness level is updated with the compensation pixel value.

The compensation pixel value includes compensation sub-pixel values corresponding to a plurality of sub-pixel points. Updating the pixel value of the pixel point of the defective region at the preset brightness level with the compensation pixel value to form the compensation image may include: updating the sub-pixel value of the defective sub-pixel point at the preset brightness level with the compensation sub-pixel value to form the compensation image.

Before performing the interpolation computation on the sub-pixel values of different sub-pixel points in the normal region at the periphery of the defective region of the second captured image, the method may further include: determining whether an area of the defective region is less than a preset value; when the area of the defective region is smaller than the preset value, updating the sub-pixel values of the defective sub-pixel points with a sub-pixel value of a normal sub-pixel point closest to the defective region.

Performing the interpolation computation on the sub-pixel values of different defective sub-pixel points of the second captured image to determine the compensation sub-pixel values for the defective sub-pixel points at the preset brightness level, includes the following steps: selecting a defective sub-pixel point in the defective region; extracting sub-pixel values of a plurality of sub-pixel points in the second captured image; in at least four different directions, searching a normal sub-pixel point closest to the defective sub-pixel point from the normal region, and recording the sub-pixel values of at least four normal sub-pixel points; and taking a distance between the defective sub-pixel point and the normal sub-pixel point as a weight, and performing a weighting operation on the sub-pixel values of the at least four normal sub-pixel points to obtain the compensation sub-pixel value for the defective sub-pixel point.

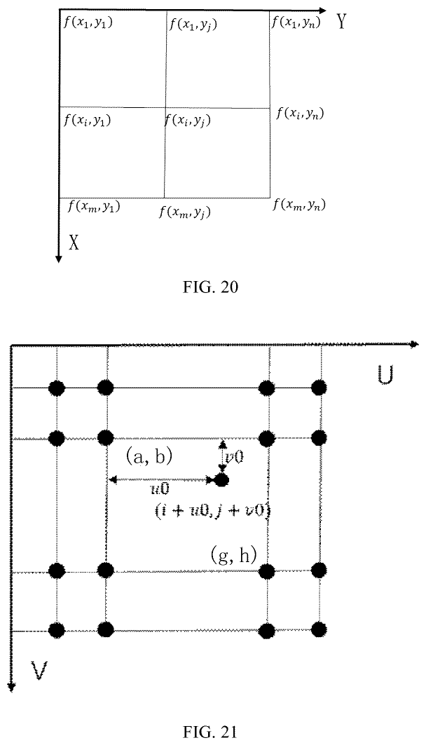

As shown in FIG. 20, the compensation sub-pixel value for the defective sub-pixel point may be determined by a bilinear interpolation method.

Taking the distance between the defective sub-pixel point and the normal sub-pixel point as the weight, and performing the weighting operation on the sub-pixel values of the four normal sub-pixel points to obtain the compensation sub-pixel value for the defective sub-pixel point, specifically includes the following steps.

Firstly, a linear interpolation is performed on the four normal sub-pixel points in the X direction, and the following results are obtained:

$$\begin{matrix}f ( {x}_{i} , {y}_{1} ) = \frac{i - 1}{m - 1} f ( {x}_{1} , {y}_{1} ) + \frac{m - i}{m - 1} f ( {x}_{m} , {y}_{1} ) \\ f ( {x}_{i} , {y}_{n} ) = \frac{i - 1}{m - 1} f ( {x}_{1} , {y}_{n} ) + \frac{m - i}{m - 1} f ( {x}_{m} , {y}_{n} )\end{matrix}$$

Then, a linear interpolation is performed on the four normal sub-pixel points in the Y direction, and the following results are obtained:

$$\begin{matrix}f ( {x}_{1} , {y}_{j} ) = \frac{j - 1}{n - 1} f ( {x}_{1} , {y}_{1} ) + \frac{n - j}{n - 1} f ( {x}_{1} , {y}_{n} ) \\ f ( {x}_{n} , {y}_{j} ) = \frac{j - 1}{n - 1} f ( {x}_{n} , {y}_{1} ) + \frac{n - j}{n - 1} f ( {x}_{n} , {y}_{n} )\end{matrix}$$

Finally, an interpolation result of the defective region is:

$$f ( {x}_{i} , {y}_{j} ) = \frac{( i - 1 ) * ( j - 1 )}{( m - 1 ) * ( n - 1 )} f ( {x}_{1} , {y}_{1} ) + \frac{( i - 1 ) * ( n - j )}{( m - 1 ) * ( n - 1 )} f ( {x}_{1} , {y}_{n} ) + \frac{( m - i ) * ( j - 1 )}{( m - 1 ) * ( n - 1 )} f ( {x}_{m} , {y}_{1} ) + \frac{( m - i ) * ( n - j )}{( m - 1 ) * ( n - 1 )} f ( {x}_{m} , {y}_{n} )$$

in which, f (xᵢ, yⱼ) is the compensation sub-pixel value for the defective sub-pixel point, f (x₁, y₁), f (x₁, yₙ), f (xₘ, y₁) and f (xₘ, yₙ) are all sub-pixel values of the normal sub-pixel points,

$$\frac{( i - 1 ) * ( j - 1 )}{( m - 1 ) * ( n - 1 )}$$

is a weight of f (x₁, y₁),

$$\frac{( i - 1 ) * ( n - j )}{( m - 1 ) * ( n - 1 )}$$

is a weight of f (x₁, yₙ),

$$\frac{( m - i ) * ( j - 1 )}{( m - 1 ) * ( n - 1 )}$$

is a weight of f (xₘ, y₁), and

$$\frac{( m - i ) * ( n - j )}{( m - 1 ) * ( n - 1 )}$$

is a weight of f (xₘ, yₙ), i and m represent sequence numbers of different x, and j and n represent sequence numbers of different y.

Determining the compensation sub-pixel values for the defective sub-pixel points includes, but is not limited to, the bilinear interpolation method, and other interpolation methods such as a cubic interpolation method, a double wavelet method and a B spline method may also be used.

As shown in FIG. 21, the compensation sub-pixel value for the defective sub-pixel point may be determined by the cubic interpolation.

The compensation sub-pixel value at the defective sub-pixel point (i+u₀, j+v₀) may be obtained from 16 normal sub-pixel points in the normal region, that is, a weighted average of these 16 normal sub-pixel points. The weight of each compensated sub-pixel value is determined by the distance between the normal sub-pixel point and the defective sub-pixel point. This distance includes a distance between the defective sub-pixel point and the normal sub-pixel point in the first direction and a distance between the defective sub-pixel point and the normal sub-pixel point in the second direction. The first direction may be a u direction in the coordinate axis, and the second direction may be a v direction in the coordinate axis.

Taking the distance between the defective sub-pixel point and the normal sub-pixel point as the weight, and performing the weighting operation on the sub-pixel values of sixteen normal sub-pixel points to obtain the compensation sub-pixel value for the defective sub-pixel point, including:

$$f ( a + {u}_{0} , b + {v}_{0} ) = A * B * C$$

in which,

$$A = [ w ( 1 + u ) w ( u ) w ( 1 - u ) w ( 2 - u ) ] \\ C = [ ( 1 + v ) w ( v ) w ( 1 - v ) w ( 2 - v ) ] \\ B = [ \begin{matrix}f ( a - 1 , b - 1 ) & f ( a - 1 , b ) & f ( a - 1 , b ) & f ( a - 1 , g + 1 ) \\ f ( a , b - 1 ) & f ( a , b ) & f ( a , h ) & f ( a , h + 1 ) \\ f ( a , b - 1 ) & f ( a , b ) & f ( g , h ) & f ( g , h + 1 ) \\ f ( g + 1 , b - 1 ) & f ( g + 1 , b ) & f ( g + 1 , h ) & f ( g + 1 , h + 1 )\end{matrix} ]$$

a weighted sum function is:

$$w ( x ) = \{ \begin{matrix}1 - 2 {\vert x \vert}^{2} + {\vert x \vert}^{3} , & \vert x \vert < 1 \\ 4 - 8 \vert x \vert + 5 {\vert x \vert}^{2} - {\vert x \vert}^{3} , & 1 \leq \vert x \vert < 2 \\ 0 & \vert x \vert \geq 2\end{matrix}$$

one normal sub-pixel point is (a, b), another normal sub-pixel point is (g, h), and u₀ and v₀ are distances between the defective sub-pixel point and the normal sub-pixel point (a, b) in a first direction and a second direction, respectively, where the distances are normalized as

$$u = \frac{{u}_{0}}{g - a} and \\ v = \frac{{v}_{0}}{h - b} ,$$

and a weight of the normal sub-pixel point (a, b) is w=w(u)*w(v); and A*C is a weight array of all normal sub-pixel points, B is a sub-pixel value array of all normal sub-pixel points, and f (a+u₀, b+v₀) is the compensation sub-pixel value for the defective sub-pixel point.

As mentioned above, the preset brightness level includes a plurality of preset brightness level values, and one second captured image may be acquired based on each preset brightness level value respectively. Therefore, it is necessary to perform the interpolation computation on the sub-pixel value of a normal sub-pixel point, corresponding to a defective sub-pixel point, at periphery of the defective sub-pixel point in the second captured image corresponding to each preset brightness level value, to determine the compensation sub-pixel values of the defective sub-pixel point corresponding to the plurality of preset brightness level values. The sub-pixel values of defective sub-pixel points are updated with each compensation sub-pixel value at each preset brightness level value to form different compensation images.

It should be noted that when capturing the second captured image, because the image acquisition apparatus is unable to be completely opposite to the display region of the display panel, there will be a position offset, which may include an X-direction offset and a Y-direction offset. Therefore, it is necessary to correct a capturing angle to perform the interpolation computation on the sub-pixel values of different defective sub-pixel points in the second captured image to ensure that correct sub-pixel points are captured.

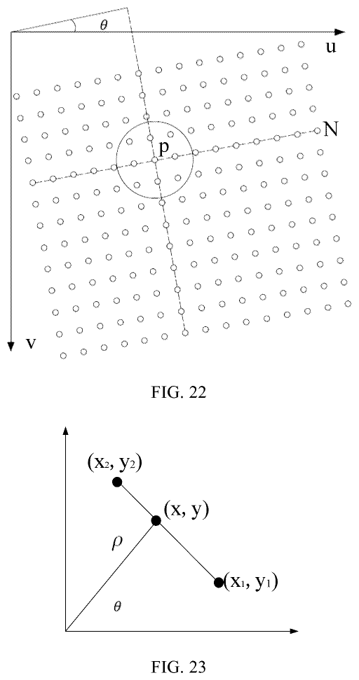

As shown in FIG. 22, a deflection angle of the second captured image is first determined. Due to the position deviation of the display panel, a deflection angle θ is generated. Generally speaking, the deflection angle θ is −10°˜10°. A circle is drawn with a point P selected as a center point from the second captured image, and nine sub-pixel points are drawn in the circle. Straight lines are drawn from the point P to three points on its right, and an included angle θ between the line with the most sub-pixel points on the straight line and the coordinate axis u is the deflection angle.

Secondly, the coordinate axis of the second captured image is converted based on the deflection angle, and the coordinate values of the sub-pixel points in the second captured image are converted to eliminate the deflection angle of the second captured image. A connecting line between the point on the line and the point p is defined as ρ, x=ρ cos θ, y=ρ sin θ.

As shown in FIG. 23, different ρ and θ are determined based on offset straight lines where different sub-pixel points are located. The coordinate axis conversion is performed on the second captured image and the display panel based on different ρ and θ, the position of each sub-pixel point of the display panel corresponding to the second captured image is determined. For example, x₁=ρ₁ cos θ₁, y₁=ρ₁ cos θ₁, so as to determine a corrected point (x₁, y₁), x₂=ρ₂ cos θ₂, y₂=ρ₂ cos θ₂, so as to determine a corrected point (x₂, y₂), and x=ρ cos θ, y=ρ cos θ, so as to determine the corrected points (x, y).

Usually, there is moire in the second captured image. Because the moire is mainly produced by a periodic brightness pattern by optical interference, a model corresponding to the moire may be determined through optical modeling, and the sub-pixel value of each sub-pixel point may be subtracted based on the model to get a final sub-pixel value of each sub-pixel point.

An example implementation of the present disclosure further provides a computer-readable storage medium, which may be implemented in the form of a program product, including a program code. The program code causes an electronic device to perform the steps according to various exemplary embodiments of the present disclosure described in the above-mentioned “example method” part of the description when the program product is run on the electronic device. In an implementation, the program product may be implemented as a portable compact disc read-only memory (CD-ROM) and includes a program code, and may be run on an electronic device, such as a personal computer. However, the program product of the present disclosure is not limited to this. In this document, the readable storage medium may be any tangible medium containing or storing a program, which may be used by or in combination with an instruction execution system, apparatus or device.

The program product may employ any combination of one or more readable medium. The readable medium may be a readable signal medium or a readable storage medium. The readable storage medium may be, for example, but not limited to, an electrical, magnetic, optical, electromagnetic, infrared, or semiconductor system, apparatus, or device, or any combination of them. More specific examples of readable storage medium (non-exhaustive lists) include an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of them.

The computer-readable signal medium may include a data signal that is propagated in a baseband or as part of a carrier, where readable program code is carried. Such a propagated data signal may take a variety of forms, including, but not limited to, an electromagnetic signal, an optical signal, or any suitable combination of them. The readable signal medium may also be any readable medium other than the readable storage medium. The readable medium may send, propagate, or transmit a program used by or combined with an instruction execution system, apparatus, or device.

The program code included on the readable medium may be transmitted by any suitable medium, including but not limited to wireless, wired, optical cable, RF, etc., or any suitable combination of the foregoing.

Program code for performing the operations of the present disclosure may be written in any combination of one or more programming languages. The programming languages include object-oriented programming languages, such as Java, C++, etc. The programming languages also includes conventional procedural programming languages, such as “C” languages or similar programming languages. The program code may be executed entirely on the user computing device, partly on the user device, as a stand-alone software package, partly on the user computing device and partly on the remote computing device, or entirely on the remote computing device or server. In situations involving a remote computing device, a remote computing device may be connected to a user computing device through any type of network, including a local area network (LAN) or a wide area network (WAN), or may be connected to an external computing device (e.g., being connected through the Internet via an Internet Service Provider).

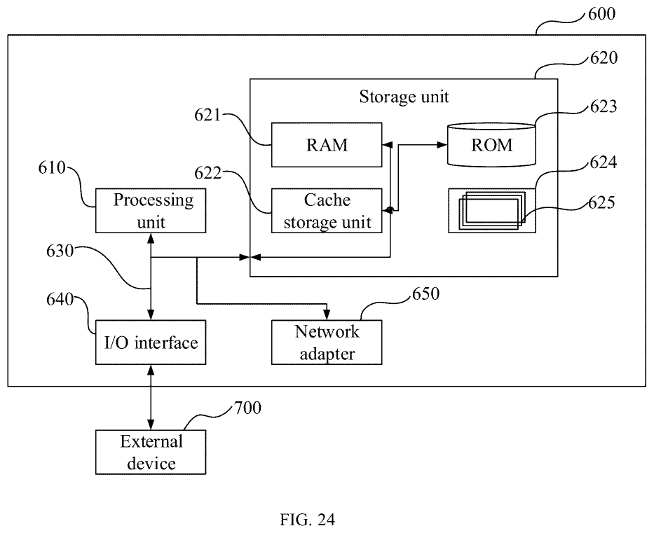

An example embodiment of the present disclosure further provides an electronic device, which may be a processor. The electronic device will be described below with reference to FIG. 24. It should be understood that the electronic device 600 shown in FIG. 24 is only an example, and should not bring any limitation to the functions and usage scope of the embodiments of the present disclosure.

As shown in FIG. 24, the electronic device 600 is represented in the form of a general-purpose computing device. The components of the electronic device 600 may include, but are not limited to, at least one processing unit 610, at least one storage unit 620, and a bus 630 connecting different system components (including the storage unit 620 and the processing unit 610).

The storage unit stores a program code, and the program code may be executed by the processing unit 610, such that the processing unit 610 executes the steps according to various example embodiments of the present disclosure described in the foregoing “example method” part of the description. For example, the processing unit 610 may execute the method steps shown in FIG. 17 and the like.

The storage unit 620 may include a volatile storage unit, such as a random access storage unit (RAM) 621 and/or a cache storage unit 622, and may further include a read-only storage unit (ROM) 623.

The storage unit 620 may also include a program/utility 624 having a set of (at least one) program module 625, including but are not limited to: an operating system, one or more applications, other program modules and program data. Each of these examples or some combination of them may include an implementation of a network environment.

The bus 630 may include a data bus, an address bus and a control bus.

The electronic device 600 may also communicate with one or more external devices 700 (e.g., a keyboard, a pointing device, a Bluetooth device, etc.). Such communication may be performed through an input/output (I/O) interface 640. The electronic device 600 may also communicate with one or more networks (e.g., a local area network (LAN), a wide area network (WAN), and/or a public network, such as the Internet) through the network adapter 650. As shown, the network adapter 650 communicates with other modules of the electronic device 600 through the bus 630. It should be understood that although not shown in the drawings, other hardware and/or software modules may be used in conjunction with the electronic device 600, including but not limited to: microcode, device drivers, redundant processing units, external disk drive arrays, RAID systems, tape drives, and data backup storage systems, etc.

It should be noted that although several modules or units of a device for action execution are mentioned in the above detailed description, such partitioning is not mandatory. Indeed, according to exemplary implementations of the present disclosure, the features and functions of two or more modules or units described above may be concretized within one module or unit. Conversely, the features and functions of one module or unit described above may be further divided into a plurality of modules or units to be concretized.

Those skilled in the art can understand that various aspects of the present disclosure may be implemented as a system, a method or a program product. Therefore, various aspects of the present disclosure may be embodied in the following forms: a complete hardware implementation, a complete software implementation (including firmware, microcode, etc.), or a combination implementation of hardware and software aspects, which may be collectively referred to as a “circuit”, “module” or “system” here. Other implementations of the present disclosure will easily occur to those skilled in the art after considering the description and practicing the invention disclosed herein. The present disclosure is intended to cover any variation, usage or adaptation of the present disclosure, which follow the general principles of the present disclosure and include common sense or common technical means in this technical field that are not disclosed in the present disclosure. The description and implementations are to be regarded as exemplary only, with the true scope and spirit of the present disclosure being indicated by the claims.

It should be understood that the present disclosure is not limited to the precise structure that has been described above and illustrated in the accompanying drawings, and that various modifications and changes may be made without departing from the scope of the present disclosure. The scope of the present disclosure is limited only by the appended claims.

1. A method for compensating a display defect, comprising:
acquiring a first captured image of a display panel;
identifying a defective region and a normal region of the display panel based on the first captured image, wherein the defective region comprises a defective pixel point and the normal region comprises a normal pixel point;
acquiring a second captured image of the display panel at a preset brightness level when the display panel is in a display state;
obtaining a compensation pixel value for the defective pixel point at the preset brightness level by performing an interpolation computation on a pixel value of the normal pixel point of the second captured image;
repeatedly acquiring compensation pixel values for all defective pixel points; and
updating a pixel value of the defective pixel point corresponding to the preset brightness level with the compensation pixel value, to form a compensation image.

2. The method for compensating the display defect according to claim 1, wherein the pixel point comprises a plurality of different sub-pixel points, and the compensation pixel value comprises a plurality of compensation sub-pixel values corresponding to the sub-pixel points,
obtaining the compensation pixel value for the defective pixel point at the preset brightness level by performing the interpolation computation on a pixel value of the normal pixel point of the second captured image comprises: performing the interpolation computation on a sub-pixel values of a normal sub-pixel point, corresponding to a defective sub-pixel point, at periphery of the defective sub-pixel points of the second captured image, to determine the compensation sub-pixel value for the defective sub-pixel point at the preset brightness level; and
updating the pixel value of the pixel point in the defective region at the preset brightness level with the compensation pixel value to form the compensation image comprises: updating the sub-pixel value of the defective sub-pixel point at the preset brightness level with the compensation sub-pixel value, to form the compensation image.

3. The method for compensating the display defect according to claim 2, wherein,
performing the interpolation computation on the sub-pixel values of the normal sub-pixel point, corresponding to the defective sub-pixel point, at the periphery of the defective sub-pixel points of the second captured image to determine the compensation sub-pixel value for the defective sub-pixel point at the preset brightness level comprises:
selecting one defective sub-pixel point in the defective region;
extracting the sub-pixel values of the plurality of sub-pixel points in the second captured image;
searching a normal sub-pixel point closest to the defective sub-pixel point from the normal region in at least four different directions, and recording the sub-pixel values of at least four normal sub-pixel points; and
taking a distance between the defective sub-pixel point and the normal sub-pixel point as a weight, and performing a weighting operation on the sub-pixel values of the at least four normal sub-pixel points to obtain the compensation sub-pixel value for the defective sub-pixel point.

4. The method for compensating the display defect according to claim 3, wherein taking the distance between the defective sub-pixel point and the normal sub-pixel point as the weight, and performing the weighting operation on the sub-pixel values of the at least four normal sub-pixel points to obtain the compensation sub-pixel value for the defective sub-pixel point comprises:
$$f ( {x}_{i} , {y}_{j} ) = \frac{( i - 1 ) * ( j - 1 )}{( m - 1 ) * ( n - 1 )} f ( {x}_{1} , {y}_{1} ) + \frac{( i - 1 ) * ( n - j )}{( m - 1 ) * ( n - 1 )} f ( {x}_{1} , {y}_{n} ) + \frac{( m - 1 ) * ( j - 1 )}{( m - 1 ) * ( n - 1 )} f ( {x}_{m} , {y}_{1} ) + \frac{( m - i ) * ( n - j )}{( m - 1 ) * ( n - 1 )} f ( {x}_{m} , {y}_{n} )$$
wherein, f (xᵢ, yⱼ) is the compensation sub-pixel value for the defective sub-pixel point, f (x₁, y₁), f (x₁, yₙ), f (xₘ, y₁) and f (xₘ, yₙ) are sub-pixel values of the normal sub-pixel points,
$$\frac{( i - 1 ) * ( j - 1 )}{( m - 1 ) * ( n - 1 )}$$
is a weight of f (x₁, y₁),
$$\frac{( i - 1 ) * ( n - j )}{( m - 1 ) * ( n - 1 )}$$
is a weight of f (x₁, yₙ),
$$\frac{( m - i ) * ( j - 1 )}{( m - 1 ) * ( n - 1 )}$$
is a weight of f (xₘ, y₁), and
$$\frac{( m - i ) * ( n - j )}{( m - 1 ) * ( n - 1 )}$$
is a weight of f (xₘ, yₙ), i and m represent sequence numbers of different x, and j and n represent sequence numbers of different y.

5. The method for compensating the display defect according to claim 3, wherein taking the distance between the defective sub-pixel point and the normal sub-pixel point as the weight, and performing the weighting operation on the sub-pixel values of the at least four normal sub-pixel points to obtain the compensation sub-pixel value for the defective sub-pixel point comprises:
$$f ( a + {u}_{0} , b + {v}_{0} ) = A * B * C$$
wherein,
$$A = [ w ( 1 + u ) w ( u ) w ( 1 - u ) w ( 2 - u ) ] \\ C = [ w ( 1 + v ) w ( v ) w ( 1 - v ) w ( 2 - v ) ] \\ B = [ \begin{matrix}f ( a - 1 , b - 1 ) & f ( a - 1 , b ) & f ( a - 1 , b ) & f ( a - 1 , g + 1 ) \\ f ( a , b - 1 ) & f ( a , b ) & f ( a , h ) & f ( a , h + 1 ) \\ f ( a , b - 1 ) & f ( a , b ) & f ( g , h ) & f ( g , h + 1 ) \\ f ( g + 1 , b - 1 ) & f ( g + 1 , b ) & f ( g + 1 , h ) & f ( g + 1 , h + 1 )\end{matrix} ]$$
a weighted sum function is:
$$w ( x ) = \{ \begin{matrix}1 - 2 {\vert x \vert}^{2} + {\vert x \vert}^{3} , & \vert x \vert < 1 \\ 4 - 8 \vert x \vert + 5 {\vert x \vert}^{2} - {\vert x \vert}^{3} , & 1 \leq \vert x \vert < 2 \\ 0 & \vert x \vert \geq 2\end{matrix}$$
one normal sub-pixel point is (a, b), another normal sub-pixel point is (g, h), and u₀ and v₀ are distances between the defective sub-pixel point and the normal sub-pixel point (a, b) in a first direction and a second direction, respectively, wherein the distances are normalized as
$$u = \frac{{u}_{0}}{g - a} and \\ v = \frac{{v}_{0}}{h - b} ,$$
and a weight of the normal sub-pixel point (a, b) is w=w(u)*w(v); and A*C is a weight array of all normal sub-pixel points, B is a sub-pixel value array of all normal sub-pixel points, and f (a+u₀, b+v₀) is the compensation sub-pixel value for the defective sub-pixel point.

6. The method for compensating the display defect according to claim 2, wherein the first captured image is acquired when the display panel is set in a non-display state, and identifying the defective region of the display panel based on the first captured image comprises:
extracting the sub-pixel value of each sub-pixel point in the first captured image;
when a sub-pixel value of a sub-pixel point exceeds a first preset sub-pixel value interval, determining the sub-pixel point as the defective sub-pixel point; and
determining all the defective sub-pixel points, wherein all the defective sub-pixel points form the defective region.

7. The method for compensating the display defect according to claim 6, wherein the first captured image is acquired when the display panel is set in the display state, and identifying the defective region of the display panel based on the first captured image comprises:
extracting the sub-pixel value of each sub-pixel point in the first captured image;
when a sub-pixel value of a sub-pixel point exceeds a second preset sub-pixel value interval, determining the sub-pixel point as the defective sub-pixel point, wherein the second preset sub-pixel value interval is greater than the first preset sub-pixel value interval; and
determining all the defective sub-pixel points, wherein all the defective sub-pixel points form the defective region.

8. The method for compensating the display defect according to claim 2, wherein before performing the interpolation computation on the sub-pixel values of the normal sub-pixel point, corresponding to the defective sub-pixel point, at the periphery of the defective sub-pixel points of the second captured image, the method further comprises:
determining a deflection angle of the second captured image; and
performing a coordinate axis conversion on the second captured image and performing a coordinate value conversion on sub-pixel points in the second captured image based on the deflection angle, to eliminate the deflection angle of the second captured image.

9. The method for compensating the display defect according to claim 2, wherein before performing the interpolation computation on the sub-pixel values of the normal sub-pixel point, corresponding to the defective sub-pixel point, at the periphery of the defective sub-pixel points of the second captured image, the method further comprises:
determining whether an area of the defective region is less than a preset value; and
when the area of the defective region is less than the preset value, updating the sub-pixel value of the defective sub-pixel point with a sub-pixel value of a normal sub-pixel point closest to the defective region.

10. The method for compensating the display defect according to claim 1, wherein before acquiring the first captured image of the display panel, the method further comprises:
acquiring a third captured image when the display panel is in a non-display state;
determining whether a foreign matter presents on the display panel based on the third captured image; and
cleaning the display panel in case that the foreign matter presents on the display panel.

11. The method for compensating the display defect according to claim 2, wherein the preset brightness level comprises a plurality of preset brightness level values, and the compensation sub-pixel value for the defective sub-pixel point comprise a plurality of compensation sub-pixel values corresponding to the plurality of preset brightness level values, and the method further comprises:
updating the sub-pixel value of the defective sub-pixel point with the compensation sub-pixel value corresponding to the preset brightness level, to form the compensation image.

12. (canceled)

13. A non-transitory computer-readable storage medium, storing with a computer program thereon, wherein, when the computer program is executed by a processor, the processor is configured to:
acquire a first captured image of a display panel;
identify a defective region and a normal region of the display panel based on the first captured image, wherein the defective region comprises a defective pixel point and the normal region comprises a normal pixel point;
acquire a second captured image of the display panel at a preset brightness level when the display panel is in a display state;
obtain a compensation pixel value for the defective pixel point at the preset brightness level by performing an interpolation computation on a pixel value of the normal pixel point of the second captured image;
repeatedly acquire compensation pixel values for all defective pixel points; and
update a pixel value of the defective pixel point corresponding to the preset brightness level with the compensation pixel value, to form a compensation image.

14. An electronic device, comprising:
a processor; and
a memory, configured to store an executable instruction of the processor;
wherein the processor, via executing the executable instruction, is configured to;
acquire a first captured image of a display panel;
identify a defective region and a normal region of the display panel based on the first captured image, wherein the defective region comprises a defective pixel point and the normal region comprises a normal pixel point;
acquire a second captured image of the display panel at a preset brightness level when the display panel is in a display state;
obtain a compensation pixel value for the defective pixel point at the preset brightness level by performing an interpolation computation on a pixel value of the normal pixel point of the second captured image;
repeatedly acquire compensation pixel values for all defective pixel points; and
update a pixel value of the defective pixel point corresponding to the preset brightness level with the compensation pixel value, to form a compensation image.

15. A display apparatus comprising a display panel and a controller, the controller comprising a compensation algorithm processor and a compensation parameter storage, the compensation parameter storage being configured to store an electrical compensation parameter and an optical compensation parameter, the compensation algorithm processor being configured to receive first image data of an image to be displayed on the display panel and call the electrical compensation parameter and the optical compensation parameter stored in the compensation parameter storage according to the first image data and perform a compensation calculation to generate compensated second image data to be displayed, wherein,
the optical compensation parameter is generated based on the compensation image according to claim 1 and the image to be displayed.

16. The display apparatus according to claim 15, wherein the controller further comprises an image processor, a driving controller and a sensing data converter; wherein the sensing data converter is configured to convert a sensing signal sensed by the display panel into a digital signal and generate the electrical compensation parameter based on the digital signal; the image processor is configured to receive the second image data, and convert the second image data into digital quantity information required to light a corresponding sub-pixel; and the driving controller is configured to output a driving schedule required based on the digital quantity information, and display the image to be displayed.

17. The display apparatus according to claim 15, wherein the display apparatus comprises: a substrate and a plurality of sub-pixels located in a display area, wherein the sub-pixels are arranged in a plurality of rows along a first direction and in a plurality of columns along a second direction, each row of sub-pixels comprises a plurality of sub-pixels, each column of sub-pixels comprises a plurality of sub-pixels, and the first direction and the second direction intersect with each other.

18. The display apparatus according to claim 17, wherein the display apparatus further comprises: a plurality of gate lines and a plurality of data lines provided on a side of the substrate and located in the display area, wherein the plurality of gate lines extend in the first direction and the plurality of data lines extend in the second direction, sub-pixels in a same row are electrically connected with at least one of the gate lines, and sub-pixels in a same column are electrically connected with one of the data lines.

19. The display apparatus according to claim 18, wherein each of the sub-pixels comprises a pixel driving circuit and a light emitting device electrically connected with the pixel driving circuit, one of the gate lines is electrically connected with a plurality of the pixel driving circuits of the sub-pixels in the same row, and one of the data lines is electrically connected with a plurality of the pixel driving circuits of the sub-pixels in the same column.

20. The display apparatus according to claim 19, wherein the pixel driving circuit comprises: a switching transistor, a driving transistor, a sensing transistor and a storage capacitor, wherein,
a control electrode of the switching transistor is electrically connected with a first gate signal terminal, a first electrode of the switching transistor is electrically connected with a data signal terminal, a second electrode of the switching transistor is electrically connected with a first node, the first gate signal terminal is electrically connected with one of the gate lines, and the data signal terminal is electrically connected with one of the data lines;
the switching transistor is configured to transmit a data signal received at the data signal terminal to the first node in response to a first scan signal received at the first gate signal terminal;
a control electrode of the driving transistor is electrically connected with the first node, a first electrode of the driving transistor is electrically connected with a sixth voltage signal terminal, and a second electrode of the driving transistor is electrically connected with a second node;
the driving transistor is configured to be turned on under a control of a voltage of the first node, generate a driving signal according to the voltage of the first node and a sixth voltage signal received at the sixth voltage signal terminal, and transmit the driving signal to the second node;
a first terminal of the storage capacitor is electrically connected with the first node, and a second terminal of the storage capacitor is electrically connected with the second node;
the switching transistor charges the storage capacitor while charging the first node;
an anode of the light emitting device is electrically connected with the second node, and a cathode of the light emitting device is electrically connected with a seventh voltage signal terminal;
the light emitting device is configured to emit light under a driving of the driving signal;
a control electrode of the sensing transistor is electrically connected with a second gate signal terminal, a first electrode of the sensing transistor is electrically connected with the second node, a second electrode of the sensing transistor is electrically connected with a sensing signal terminal, the second gate signal terminal is electrically connected with another one of the gate lines, and the sensing signal terminal is electrically connected with another one of the data lines; and
the sensing transistor is configured to detect a threshold voltage and/or carrier mobility of the driving transistor in response to a second scan signal received at the second gate signal terminal.

21. The method for compensating the display defect according to claim 7, wherein the first preset sub-pixel value interval is 30˜70 nits; and the second preset sub-pixel value interval is 50˜100 nits.
